(19) United States
(12) Patent Application Publication
(10) Pub. No.: US 2005/0204997 A1
(43) Pub. Date: Sep. 22, 2005

(54) Data display device for vehicles

(75) Inventor: Joel Fournier, Cergy Saint Christophe (FR)

Correspondence Address: FOLEY & LARDNER, 777 EAST WISCONSIN AVENUE, SUITE 3800, MILWAUKEE, WI, 53202-5308, US

(73) Assignee: JOHNSON CONTROLS AUTOMOTIVE ELECTRONICS

(21) Appl. No.: 10/503,824

(22) PCT Filed: Feb. 7, 2003
(86) PCT No.: PCT/FR03/00404

§ 371 Date: May 2, 2005

(30) Foreign Application Priority Data
Feb. 7, 2002 (FR) 02/01504

(51) Int. Cl. G09F 9/00; H01H 9/00

(52) U.S. Cl. 116/284; 116/309; 340/815.5; 200/316

(57) ABSTRACT

A device for controlling a function of a vehicle includes at least one manual control member and a display configured to display information relating to the function of the vehicle. The image from the display may be viewed on a surface of the manual control member. The device may further include an optical element, such as a lens, between the display and the manual control member where an image projected from the display by the optical element may be viewed on the surface of the manual control member.

### BACKGROUND

The invention relates to the area of vehicles, in particular automobile vehicles, and especially to the display of information intended for the people inside the vehicle.

Liquid crystal displays (LCDs) are currently used to display information relating to the operation of the vehicle or its accessories. Luminescent displays such as light emitting diodes (LEDs) or vacuum fluorescent displays, commonly known by the abbreviation VFD, are also used. This latter type comprises a cathode tube of the triode type having an emitting heated cathode, accelerating grids and phosphorous-covered anodes. The grids and anodes are arranged in a specific pattern corresponding to the information which it is desired to display. A display of this type has the advantage of being very luminous when active. It should be noted that its surface is black when it is not active. The image formed thus contrasts well and is satisfactorily distinct at the usual distance. However, it is mounted on a printed circuit board and takes up a relatively large amount of space with respect to the space available for the display. It is not simple to implement. It is also frequently deeply positioned at some distance behind the surface of the dashboard. As the opening in the dashboard cannot be very large there is a problem of having a small viewing angle in which it is possible to see the displayed image. The people inside the passenger cell of the vehicle who are not on the axis of the display must thus move towards the cone in which the display is visible. The movement is all the greater and more inconvenient the smaller the distance of the observer from the dashboard, as is the case in an automobile vehicle.

Beside these display means are the buttons for controlling the function concerned, for example, the ventilation, heating and, in some cases, air conditioning. These buttons are illuminated at night, possibly from the rear face by means of a light source shining through a translucent wall element. In order to facilitate recognition thereof, the button often has a translucent element on which an appropriate symbol has been provided.

### SUMMARY

The applicant has set himself the objective of making the image provided by a VFD type display or an equivalent visible on these buttons from any part of the passenger cell of the vehicle (both during the day and the night).

The applicant has also set himself the objective of making the various information easier to read by concentrating it into a smaller space.

The applicant has managed to achieve these objectives with a device for controlling a function of a vehicle comprising at least one manual control member and a means for displaying information relating to the said function comprising a luminescent display, characterised in that an optical means is interposed between the display and the manual control member, this latter comprising a surface forming a screen for viewing an image projected from the said display by the optical means.

The term luminescent display designates in particular displays of the VFD type. However, the description also relates to any type of display emitting an image able to be projected by an optical means onto a screen-forming surface.

In particular, the image is may be projected by an optical means formed by a lens disposed between the display and the surface of the manual control member.

This embodiment, by conveying the image to the surface of the manual control member, makes it easier to observe even if the observer is not positioned directly opposite the display.

The teachings hereinbelow extend to those embodiments which fall within the scope of the appended claims, regardless of whether they address or include one or more of the above-mentioned problems or objectives.

### BRIEF DESCRIPTION OF THE DRAWINGS

Other features and advantages will become clear upon reading the following description of an embodiment in relation to the attached drawings in which:

FIG. 1 is a front view of a control button on a vehicle dashboard,

FIG. 2 is a longitudinal cross-sectional view in the direction AA of FIG. 1.

### DESCRIPTION OF AN EXEMPLARY EMBODIMENT

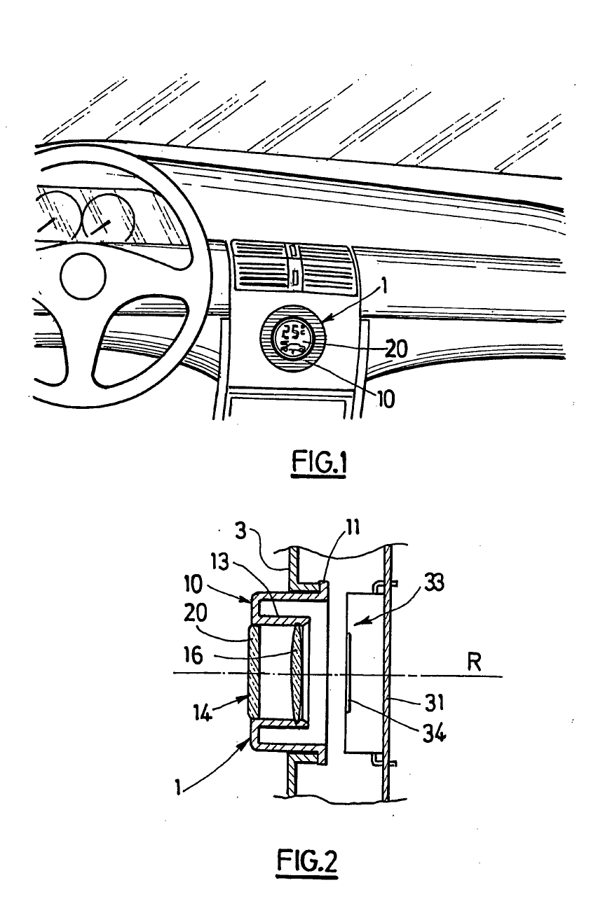

FIG. 1 shows a dashboard of an automobile vehicle illustrated in a very schematic manner. Among the various controls or indicators a button 1 is shown for controlling the air conditioning. This is a rotating button with a face which is visible from the passenger cell of the vehicle. It has an opaque annular part 10 and a translucent central part 20 which in this case indicates a temperature, for example a set temperature, as well as the condition of air inlet into the vehicle.

In FIG. 2 the longitudinal cross-section shows the button 1 housed in the wall 3 of the dashboard. It is held in axial abutment by a collar 11 extending in the radial direction around the periphery of the cylindrical annular part 10. The collar permits the rotation of the button about its axis R. This part of the button is produced from an opaque synthetic material. A concentric element 13 of a tubular shape is closed by a translucent wall. This wall 14 has a front face visible from the passenger cell of the vehicle. More precisely, this wall is translucent. It has been treated to form a screen for viewing an image formed on its rear face. At a distance from the wall 14 and in parallel therewith, a lens 16 forming an optical means in the tubular element 13 has been mounted. Inside the dashboard, at a distance from the button, is a support 31 having a printed circuit on which is mounted the display 33 which in this case is of the VFD type. In a known manner the display has a screen 34 on which the luminous source image is formed. The display 33, the lens 16 and the wall 14 form an optical system. The parameters of this system are determined in such a way that the image emitted by the display is projected onto the rear face 35 of the transparent wall of the button.

When the user acts upon the manual control button from inside the passenger cell, causing it to turn about its axis R, he implements a function, in this case the air conditioning. The means for transmitting the command to the air conditioning are not shown in FIG. 2. This command has the effect of modifying the display on the screen of the display. The user follows the progress of his command, for example the setting of a temperature, with the image which is projected onto the front face of the button. FIG. 1 shows the display of the temperature and the control of the external air inlet flaps.

Thus by means of the invention it has been possible to bring the information produced on a luminescent display, in particular on a VFD type display, onto the facade of the dashboard. This projection is centralised on the control member which is very easy to see. There is no need to search the surface of the dashboard to find the information. It will also be noted that this information, although projected onto a rotatably moveable member, remains perfectly immobile since the lens which projects the object image from the display onto the rear face of the button turns only on its focal axis R.

This arrangement thus ensures ease of viewing and added convenience for the user.

1. A device for controlling a function of a vehicle comprising:
at least one manual control member;
a means for displaying information relating to the function comprising a luminescent display; and
an optical means that is interposed between the display and the manual control member;
wherein the manual control member comprises a surface forming a screen for viewing an image projected from the display by the optical means.

2. The device as claimed in claim 1, wherein the optical means is formed by a lens interposed between the display and the surface of the control member.

3. The device as claimed in claim 2, wherein the control member is a rotating button.

4. The device as claimed in claim 3, wherein the surface forming the screen is disposed in the center of the button.

5. The device as claimed in claim 1, wherein the controlled function includes at least one of a ventilation, a heating, and an air conditioning of the vehicle.

6. The device as claimed in claim 1, wherein the control member is a rotating button.

7. The device as claimed in claim 6, wherein the surface forming the screen is disposed in the center of the button.

8. The device as claimed in claim 6, wherein the controlled function includes at least on of the ventilation, the heating, and the air conditioning of the vehicle.

9. The device as claimed in claim 1, wherein the image is configured to be displayed to a passenger at a constant orientation with respect to the dashboard as the button is rotated.

10. The device as claimed in claim 9, wherein the screen rotates as the button is rotated, but the image does not rotate as the button is rotated.

11. The device as claimed in claim 1, wherein the manual control member is configured to control the function of the vehicle and the display is configured such that the image comprises information relating to the function of the vehicle.

12. The device as claim in claim 1, wherein control member is configured to move and the display is configured such that the image changes in response to movement of the control member.

13. A device for controlling a function of a vehicle, comprising:
at least one manual control member, the manual control member comprising a surface; and
a display configured to display information relating to the function of the vehicle;
wherein an image from the display may be viewed on the surface of the manual control member.

14. The device of claim 13, further comprising an optical element between the display and the manual control member, wherein an image projected from the display by the optical element may be viewed on the surface.

15. The device of claim 14, wherein the optical element comprises a lens.

16. The device of claim 13, wherein the display is not on the surface of the manual control member.

17. The device of claim 13, wherein the information displayed by the display changes in response to changes of the manual control member.

18. The device of claim 17, wherein the manual control member is rotatable and the information displayed by the display changes in response to rotation of the manual control member.

19. The device of claim 17, wherein the manual control member is configured to control the function of the vehicle.

20. The device of claim 13, wherein the manual control member is configured to move and the device is configured such that the image from the display has a constant orientation with respect to a dashboard of the vehicle when the manual control member moves.

21. The device of claim 13, wherein the manual control member is a button and comprises a screen on which the image is projected, wherein the screen rotates as the button is rotated, but the image does not rotate as the button is rotated.

22. The device of claim 13, wherein the manual control member is a rotating button.

23. The device of claim 22, wherein the surface of the button comprises a screen and the screen is disposed in the center of the button.

24. The device of claim 13, wherein the controlled function includes at least on of the ventilation, the heating, and the air conditioning of the vehicle.

25. A device for controlling a function of a vehicle, comprising:
a means for controlling the function of the vehicle; and
a means for projecting an image relating to the function of the vehicle onto a surface of the means for controlling the function of the vehicle.
